(19) United States
(12) Patent Application Publication
(10) Pub. No.: US 2025/0070382 A1
(43) Pub. Date: Feb. 27, 2025

(54) BATTERY SYSTEMS INCLUDING BATTERY CELLS AND HYDROGEN-PERMEABLE MEMBRANES

(71) Applicant: GM GLOBAL TECHNOLOGY OPERATIONS LLC, Detroit, MI (US)

(72) Inventors: Jeremie Dernotte, Canton, MI (US); Scott E. Parrish, Farmington Hills, MI (US)

(73) Assignee: GM GLOBAL TECHNOLOGY OPERATIONS LLC, Detroit, MI (US)

(21) Appl. No.: 18/454,114

(22) Filed: Aug. 23, 2023

(51) Int. Cl. H01M 50/30; B01D 53/22; B01D 69/02; B01D 71/02; H01M 10/42; H01M 10/48

(52) U.S. Cl. CPC H01M 50/394; B01D 53/22; B01D 69/02; B01D 71/02231; H01M 10/4257; H01M 10/482; B01D 2257/108; B01D 2325/20; H01M 2010/4271; H01M 2010/4278; H01M 2220/20

(57) ABSTRACT

Battery systems including battery cells and hydrogen-permeable membranes are provided. In one example, a battery system includes a battery cell. The battery cell includes a cell enclosure disposed about a cell interior. At least one multi-layer stack is disposed in the cell interior and includes a cathode, an anode and a separator disposed therebetween. A hydrogen-permeable membrane is in fluid communication with the cell interior and is configured to selectively allow any hydrogen produced in the battery cell to pass from the cell interior through the hydrogen-permeable membrane to outside of the battery cell while substantially preventing other fluids from passing through the hydrogen-permeable membrane.

### INTRODUCTION

The present disclosure relates generally to battery systems, and more particularly, relates to battery systems including battery cells and hydrogen-permeable membranes that are in fluid communication with the battery cells.

Battery systems play a vital role in storing and supplying electrical energy (i.e., electricity) for many applications. Examples of applications that use battery systems are electric vehicles, consumer products (e.g., laptops, tables, cell phones), and energy storage systems (i.e., systems that provide electricity to houses, hospitals, data centers, entire cities, or the general power grid).

Battery systems include battery cells, which are responsible for storing and supplying electrical energy. A battery cell (i.e., electrochemical cell) is a device that generates electrical energy from chemical reactions.

### SUMMARY

A battery system is provided. The battery system includes a first battery cell. The first battery cell includes a first cell enclosure disposed about a first cell interior and at least one first multi-layer stack that is disposed in the first cell interior and that includes a first cathode, a first anode and a first separator disposed between the first anode and the first cathode. The battery system further includes a first hydrogen-permeable membrane that is in fluid communication with the first cell interior. The first hydrogen-permeable membrane is configured to selectively allow any hydrogen produced in the first battery cell to pass from the first cell interior through the first hydrogen-permeable membrane to outside of the first battery cell while substantially preventing other fluids from passing through the first hydrogen-permeable membrane.

In some embodiments, the battery system further includes a first hydrogen sensor that is in fluid communication with the first hydrogen-permeable membrane. The first hydrogen sensor is configured to detect a presence of hydrogen that has passed through the first hydrogen-permeable membrane and that is proximate the first hydrogen sensor.

In some embodiments, the first hydrogen sensor is configured to detect the presence of hydrogen in an amount of from about 1 ppm to about 1000 ppm or greater.

In some embodiments, the battery system further includes a first battery module. The first battery module includes a first plurality of battery cells, where the first plurality of battery cells includes the first battery cell and a second battery cell. The second battery cell includes a second cell enclosure defining and disposed about a second cell interior and at least one second multi-layer stack. The second multi-layer stack is disposed in the second cell interior and includes a second cathode, a second anode, and a second separator disposed between the second anode and the second cathode. The battery system further includes a second hydrogen-permeable membrane in fluid communication with the second cell interior. The second hydrogen-permeable membrane is configured to selectively allow any hydrogen produced in the second battery cell to pass from the second cell interior through the second hydrogen-permeable membrane to outside of the second battery cell while substantially preventing other fluids from passing through the second hydrogen-permeable membrane.

In some embodiments, the first hydrogen sensor is in fluid communication with the second hydrogen-permeable membrane and is configured to detect the presence of hydrogen that has passed through the second hydrogen-permeable membrane. The second hydrogen-permeable membrane is proximate to the first hydrogen sensor.

In some embodiments, the battery system further includes a cell management unit in communication with the first hydrogen sensor and is operative to determine a concentration of hydrogen and/or a rate of change of the concentration of hydrogen with respect to time in response to the presence of hydrogen detected by the first hydrogen sensor. The cell management unit is operative to compare the concentration and/or the rate of change to a corresponding predetermined threshold concentration value and/or a corresponding predetermined threshold rate of change value.

In some embodiments, the cell management unit is operative to direct a control action in response to the concentration and/or the rate of change exceeding the corresponding predetermined threshold concentration value and/or the corresponding predetermined threshold rate of change value. The control action includes transmitting a warning notification to a receiving device.

In some embodiments, the receiving device includes a battery management system.

In some embodiments, the battery system further includes a battery pack. The battery pack includes a plurality of battery modules that includes the first battery module and a second battery module. The second battery module includes a second plurality of battery cells, a third battery cell, and a fourth battery cell. The third battery cell includes a third cell enclosure defining and disposed about a third cell interior and at least one third multi-layer stack. The third multi-layer stack is disposed in the third cell interior and includes a third cathode, a third anode and a third separator disposed between the third anode and the third cathode. The battery system further includes a third hydrogen-permeable membrane that is in fluid communication with the third cell interior. The third hydrogen-permeable membrane is configured to selectively allow any hydrogen produced in the third battery cell to pass from the third cell interior through the third hydrogen-permeable membrane to the outside of the third battery cell while substantially preventing other fluids from passing through the third hydrogen-permeable membrane. The fourth battery cell includes a fourth cell enclosure defining and disposed about a fourth cell interior and at least one fourth multi-layer stack. The fourth multi-layer stack is disposed in the fourth cell interior and includes a fourth cathode, a fourth anode, and a fourth separator disposed between the fourth anode and the fourth cathode. The battery system further includes a fourth hydrogen-permeable membrane in fluid communication with the fourth cell interior. The fourth hydrogen-permeable membrane is configured to selectively allow any hydrogen produced in the fourth battery cell to pass from the fourth cell interior through the fourth hydrogen-permeable membrane to the outside of the fourth battery cell while substantially preventing other fluids from passing through the fourth hydrogen-permeable membrane.

In some embodiments, the first hydrogen sensor is in fluid communication with the second hydrogen-permeable membrane, the third hydrogen-permeable membrane, and the fourth hydrogen-permeable membrane. The first hydrogen sensor is configured to detect the presence of hydrogen that has passed through the second hydrogen-permeable membrane, the third hydrogen-permeable membrane, the fourth hydrogen-permeable membrane, or a combination thereof. The first hydrogen sensor is proximate to the first hydrogen sensor.

In some embodiments, the battery system further includes a battery management system that is in communication with the first hydrogen sensor. The battery management system is operative to determine a concentration of hydrogen and/or a rate of change of the concentration of hydrogen with respect to time in response to the presence of hydrogen detected by the first hydrogen sensor. The battery management system is operative to compare the concentration and/or the rate of change to a corresponding predetermined threshold concentration value and/or a corresponding predetermined threshold rate of change value.

In some embodiments, the battery management system is operative to direct a control action in response to the concentration and/or the rate of change exceeding the corresponding predetermined threshold concentration value and/or a corresponding predetermined threshold rate of change value. The control action includes transmitting a warning notification to a receiving device.

In some embodiments, the battery system is operably disposed in a vehicle.

In some embodiments, the hydrogen-permeable membrane has a hydrogen selectivity value of at least 99.0%.

In some embodiments, the hydrogen-permeable membrane is chosen from a polymeric, a porous ceramic/carbon, a dense ceramic, a dense metal, and combinations thereof.

In some embodiments, the dense metal includes palladium.

In some embodiments, the first battery cell is chosen from a pouch cell, a prismatic cell, or a cylindrical cell.

According to an alternative embodiment, a battery system includes a battery module. The battery module includes a cell management unit, a hydrogen sensor in communication with the cell management unit, and a plurality of battery cells. Each of the battery cells includes a cell enclosure disposed about a cell interior and at least one multi-layer stack. The multi-layer stack is disposed in the cell interior and includes a cathode, an anode and a separator disposed between the anode and the cathode. The battery system further includes a corresponding hydrogen-permeable membrane that is in fluid communication with the cell interior. The corresponding hydrogen-permeable membrane is configured to selectively allow any hydrogen produced in the corresponding battery cell to pass from the cell interior through the corresponding hydrogen-permeable membrane to outside of the corresponding battery cell while substantially preventing other fluids from passing through the corresponding hydrogen-permeable membrane. The hydrogen sensor is in fluid communication with the hydrogen-permeable membrane of each of the battery cells and is configured to detect a presence of hydrogen that has passed through the hydrogen-permeable membrane and that is proximate the hydrogen sensor. The cell management unit is operative to determine a concentration of hydrogen and/or a rate of change of the concentration of hydrogen with respect to time in response to the presence of hydrogen detected by the hydrogen sensor. The cell management unit is operative to compare the concentration and/or the rate of change to a corresponding predetermined threshold concentration value and/or a corresponding predetermined threshold rate of change value.

According to an alternative embodiment, a battery system includes a battery pack. The battery pack includes a battery management system and a plurality of battery modules. Each battery module includes a hydrogen sensor and a plurality of battery cells. Each of the battery cells includes a cell enclosure disposed about a cell interior and at least one multi-layer stack. The multi-layer stack is disposed in the cell interior and includes a cathode, an anode and a separator disposed between the anode and the cathode and a corresponding hydrogen-permeable membrane. The corresponding hydrogen-permeable membrane is in fluid communication with the cell interior and is configured to selectively allow any hydrogen produced in the corresponding battery cell to pass from the cell interior through the corresponding hydrogen-permeable membrane to outside of the corresponding battery cell while substantially preventing other fluids from passing through the corresponding hydrogen-permeable membrane. The hydrogen sensor is in fluid communication with the hydrogen-permeable membrane of each of the battery cells and is configured to detect a presence of hydrogen that has passed through the hydrogen-permeable membrane of each battery cell. The hydrogen-permeable membrane of each battery cell is proximate with the hydrogen sensor. The hydrogen sensor is in communication with the battery management system. The battery management system is operative to determine for each module a concentration of hydrogen and/or a rate of change of the concentration of hydrogen with respect to time in response to the presence of hydrogen detected by the corresponding hydrogen sensor. The battery management system is operative to compare the concentration and/or the rate of change to a corresponding predetermined threshold concentration value and/or a corresponding predetermined threshold rate of change value.

In some embodiments, the battery system is operably disposed in a vehicle.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIGS. 1-3 are schematic views of a battery system including a battery cell, according to one or more embodiments of the disclosure.

FIG. 4 is a schematic top view of a battery system including a battery module, according to one or more embodiments of the disclosure.

FIG. 5 is a schematic top view of a battery system including a battery pack with a hydrogen sensor, according to one or more embodiments of the disclosure.

FIG. 6 is a schematic top view of a battery system including a battery pack with a plurality of hydrogen sensors, according to one or more embodiments of the disclosure.

The appended drawings are not necessarily to scale and may present a somewhat simplified representation of various preferred features of the present disclosure as disclosed herein, including, for example, specific dimensions, orientations, locations, and shapes. Details associated with such features will be determined in part by the particular intended application and use environment.

### DETAILED DESCRIPTION

As required, detailed embodiments of the present disclosure are disclosed herein; however, it is to be understood that the disclosed embodiments are merely exemplary of the disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

Unless specifically stated from context, as used herein, the term “about” is understood as within a range of normal tolerance in the art, for example within 2 standard deviations of the mean. “About” can be understood as within 10%, 5%, 1%, 0.5%, 0.1%, 0.05%, or 0.01% of the stated value. “About” can alternatively be understood as implying the exact value stated. Unless otherwise clear from the context, the numerical values provided herein are modified by the term “about.”

Battery systems are designed to store and generate electricity for use in applications, for example, electric vehicles, consumer products (e.g., laptops, tablets, cell phones), and energy storage systems (e.g., systems that provide electricity to houses, hospitals, data centers, entire cities, or the general power grid). Battery systems include battery cells, which are electrochemical cells that generate electrical energy from chemical reactions and are responsible for storing and supplying electrical energy.

Battery cells are categorized as either primary cells (i.e., non-rechargeable cells) or secondary cells (i.e., rechargeable cells). In the case of rechargeable cells (e.g., lithium-ion battery cells, sodium ion battery cells, and the like), the chemical reactions that produce electricity may be reversed by applying an electrical current (i.e., electrical energy) to the rechargeable battery cells; thus, the rechargeable cell is recharged, and the electrical energy is stored as chemical energy.

Battery systems may use battery modules or battery packs to meet the specific energy needs of applications. Battery modules include a plurality of battery cells electrically connected in series and/or in parallel to achieve a desired voltage and energy capacity. Battery packs include a plurality of battery modules electrically connected in series and/or parallel to achieve a desired voltage and energy capacity.

Battery systems may monitor and manage the conditions of battery cells using a cell management unit (CMU), a battery management system (BMS), or a combination thereof. A CMU monitors and manages parameters of battery cells, such as voltages, currents, internal temperatures, and ambient temperatures. A CMU is used in connection with a battery module to collect data regarding the conditions of battery cells. A BMS also monitors and manages parameters of battery cells and is used in connection with a battery pack. Data regarding the conditions of battery cells may be fed directly into a BMS or from the CMU, depending on the battery system configuration. Data is collected via battery sensors that measure a battery cell conditions such as temperature, voltage, current, etc.

Using this data, battery systems may, for instance, manage the battery cells by diverting resources to or from battery cells depending on the condition of the battery cells. For example, if a battery cell is overheating in a specific module, the battery system may supply additional cooling resources to the battery cell to reduce the temperature of the overheating battery cell or may reduce the electrical current being supplied to or produced by the overheating battery cell.

Battery systems also may identify a non-performing battery cell. For example, a battery cell may not perform after the manufacturing process due to mechanical, electrical, or thermal battery abuse.

A non-performing cell may lead to thermal runaway. Thermal runaway describes a phenomenon in which increasing thermal energy (i.e., heat) facilitates and accelerates an uncontrollable chemical reaction that leads to rapid degradation of the battery cell. In other words, thermal runaway describes a process in which the battery cell enters an uncontrollable, self-heating state that may result in cell venting.

Battery cells, which include both primary cells and secondary cells, can be susceptible to thermal runaway. For example, lithium-ion battery cells may be susceptible to thermal runaway.

In one example, thermal runaway occurs in phases: (1) the onset of overheating, (2) heat accumulation and gas release, and (3) rapid creation of an anomalous condition. The first phase of overheating occurs when a battery cell starts to overheat. The overheating causes battery cell components to change and allows for unwanted chemical reactions to occur.

During the heat accumulation and gas release phase, the decomposition of battery cell components and exothermal chemical reactions occurring within the battery cell generate gases (e.g., hydrogen, oxygen, carbon monoxide, and carbon dioxide) within the sealed battery cell. The gases increase the heat and pressure of the battery cell, further driving the chemical reactions within the battery cell until an anomalous condition occurs. In addition, during the heat accumulation and gas release phase, the battery cell may pose a thermal threat to adjacent battery cells and potentially cause thermal runaway to occur in adjacent battery cells.

Anomalous conditions may result in thermal damage to the interior and exterior of the battery cell. Anomalous conditions may also result in a rapid expansion and loss of the battery cell's structure.

Although battery systems may identify a non-performing battery cell, battery systems are not equipped for early detection of an anomaly in a battery cell. As a result, the time between a battery system identifying an anomalous battery cell and the anomalous battery cell experiencing thermal runaway may be extremely short.

Accordingly, it is desirable to provide battery systems that address one or more of the foregoing issues, battery systems including battery packs, battery modules, battery cells, and hydrogen-permeable membranes in fluid communication with the battery cells. Furthermore, other desirable features and characteristics of the various embodiments described herein will become apparent from the subsequent detailed description and the appended claims, taken in conjunction with the accompanying drawings and this background.

The present disclosure relates generally to battery systems, and more particularly, relates to battery systems including battery cells and hydrogen-permeable membranes that are in fluid communication with battery cells.

In one or more embodiments of the disclosure, the battery system includes a first battery cell. The first battery cell includes a first cell enclosure disposed about a first cell interior and at least one first multi-layer stack. The first multi-layer stack is disposed in the first cell interior and includes a first cathode, a first anode and a first separator disposed between the first anode and the first cathode. The battery system further includes a first hydrogen-permeable membrane that is in fluid communication with the first cell interior. The first hydrogen-permeable membrane is configured to selectively allow any hydrogen produced in the first battery cell to pass from the first cell interior through the first hydrogen-permeable membrane to outside of the first battery cell while substantially preventing other fluids from passing through the first hydrogen-permeable membrane.

In one or more embodiments of the disclosure, the battery system includes a battery module. The battery module includes a plurality of battery cells. Each of the battery cells includes a cell enclosure disposed about a cell interior and at least one multi-layer stack. The multi-layer stack is disposed in the cell interior and includes a cathode, an anode, and a separator disposed between the anode and the cathode.

The battery system further includes a plurality of hydrogen-permeable membranes, wherein each of the hydrogen-permeable membranes is in fluid communication with a corresponding one of the cell interiors and is configured to selectively allow any hydrogen produced in a corresponding one of the battery cells to pass from the corresponding one of cell interiors through a corresponding one of the hydrogen-permeable membranes to outside of the corresponding one of the battery cells while substantially preventing other fluids from passing through the corresponding one of the hydrogen-permeable membranes.

The battery system further includes a hydrogen sensor that is in fluid communication with the plurality of hydrogen-permeable membranes and is configured to detect a presence of hydrogen that has passed through one or more hydrogen-permeable membranes and that is proximate the hydrogen sensor.

The battery system further includes a cell management unit that is in communication with the hydrogen sensor and is operative to determine a concentration of hydrogen and/or a rate of change of a concentration of hydrogen with respect to time in response to the presence of hydrogen detected by the hydrogen sensor and to compare the concentration and/or the rate of change to a corresponding predetermined threshold concentration value and/or a corresponding predetermined threshold rate of change value. The predetermined threshold concentration value may range from about 100 parts per million (ppm) to about 500 ppm or greater. The predetermined threshold rate of change value may range from about 20 ppm per minute to about 100 ppm per minute or greater.

In one or more embodiments of the disclosure, the battery system includes a battery pack including a plurality of battery modules and a hydrogen sensor in fluid communication with the battery modules. Each of the battery modules includes a plurality of battery cells and a plurality of hydrogen-permeable membranes each corresponding to one of the battery cells. Each of the battery cells includes a cell enclosure disposed about a cell interior, and at least one multi-layer stack. The multi-layer stack is disposed in the cell interior and includes a cathode, an anode, and a separator disposed between the anode and the cathode. Each of the hydrogen-permeable membranes is in fluid communication with a corresponding one of the cell interiors and is configured to selectively allow any hydrogen produced in a corresponding one of the battery cells to pass from the corresponding one of the cell interiors through a corresponding one of the hydrogen-permeable membranes to outside of the corresponding one of the battery cells while substantially preventing other fluids from passing through the corresponding one of the hydrogen-permeable membranes. The hydrogen sensor is in fluid communication with the plurality of hydrogen-permeable membranes and is configured to detect a presence of hydrogen that has passed through one or more hydrogen-permeable membranes and that is proximate the hydrogen sensor.

The battery system further includes a battery management system in communication with the hydrogen sensor and is operative to determine a concentration of hydrogen and/or a rate of change of a concentration of hydrogen with respect to time in response to the presence of hydrogen detected by the hydrogen sensor and to compare the concentration and/or the rate of change to a corresponding predetermined threshold concentration value and/or a corresponding predetermined threshold rate of change value. The predetermined threshold concentration value may range from about 100 ppm to about 500 ppm or greater. The predetermined threshold rate of change value may range from about 20 ppm per minute to about 100 ppm per minute or greater.

The battery system provides numerous benefits. The battery system provides for an early detection of a battery cell anomaly that could lead to a thermal runaway. The battery system also provides for reducing swelling or internal pressure build-up as a battery cell ages since the hydrogen-permeable membrane allows for hydrogen generated within the battery cell to leave the battery cell. As the battery cell ages due to charge and discharge cycles, hydrogen is generated due to the decomposition of components of the battery cells.

The battery system also provides a method for checking whether a battery cell is operating properly during the solid electrolyte interphase (SEI) formation stage of the manufacturing process of the battery cell. During the manufacturing process, a SEI layer is formed on the anode electrode from the decomposition products of the electrolytes while the battery cell is charged and discharged. Hydrogen, which is one of the decomposition products, passes through the hydrogen-permeable membranes to the outside of the battery cell and is detected by the hydrogen sensor. The detection of hydrogen indicates that the battery cell is properly operating.

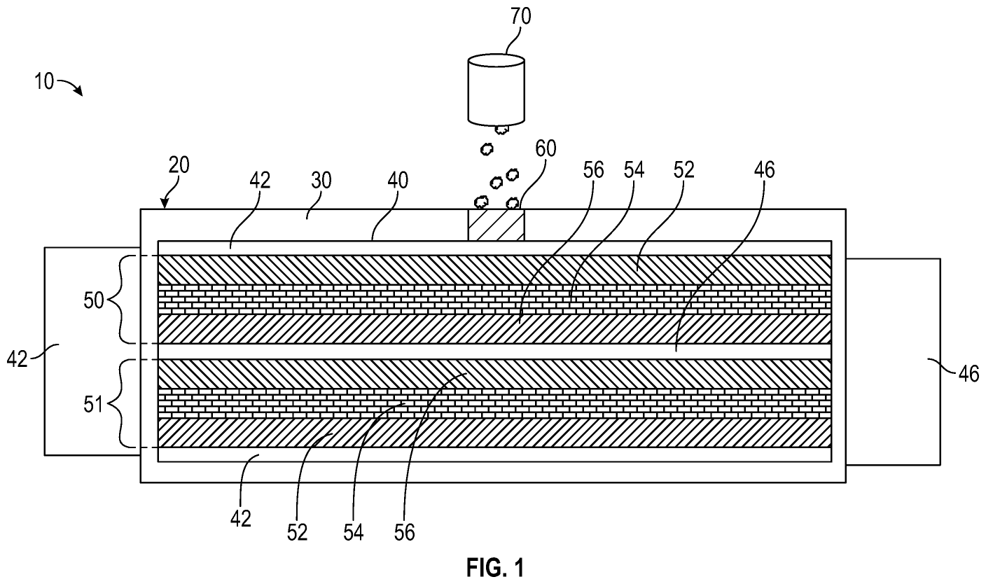

FIG. 1 illustrates a cross-sectional view of a battery system 10 including a battery cell 20. As illustrated and will be discussed below, the battery cell 20 is configured as a pouch cell. The battery cell 20 includes a cell enclosure 30 that defines and is disposed about and encases a cell interior 40. In particular, for a pouch cell, the cell enclosure 30 may be formed, for example, from a flexible pouch-like material that is impermeable or acts as a barrier to fluids, e.g., liquids such as electrolyte compositions, and various gases, for examples, hydrogen, oxygen, and the like. Non-limiting examples of pouch-like materials for cell enclosures for pouch cells include an aluminum laminated film case or the like.

In an exemplary embodiment, at least one multi-layer stack 50 is disposed in the cell interior 40. As illustrated, the battery cell 20 may include two multi-layer stacks 50, 51 that are disposed in the cell interior 40. However, it is to be understood that the battery cell 20 may include a single multi-layer stack, or more than two multi-layer stacks. Each of the multi-layer stacks 50 or 51 includes a cathode 52, an anode 56, and a separator 54 disposed between the anode 56 and the cathode 52.

The cathode 52 is an electrode where a reduction reaction takes place. Non-limiting examples of cathode-like materials for cathode 52 include lithium cobalt oxide (LiCoO₂) and lithium manganese oxide (LiMn₂O₄).

The anode 56 is an electrode where an oxidation reaction takes place. Non-limiting examples of anode-like materials for anode 56 include graphite, carbon materials, silicon-based materials, or the like.

Each multi-layer stack 50 or 51 may include electrolytes (not shown) that facilitate the transport of ions, for example lithium ions, between the cathode 52 and anode 56. An electrolyte may be disposed between the anode 56 and the separator 54 and between the cathode 52 and the separator 54. Non-limiting examples of electrolytes include liquid electrolytes (e.g., LiPF₆ LiBF₄, LiClO₄, or the like) or solid ceramic electrolytes (e.g., lithium metal oxides or the like).

The multi-layer stack 50 may include a pair of current collectors (e.g., a positive current collector 42 and a negative current collector 46). The cathode 52, separator 54, anode 56, and electrolytes (not shown) may be disposed between the pair of current collectors 42, 46. The cathode 52 may be in electrical communication with the positive current collector 42. The anode 56 may be in electrical communication with the negative current collector 46.

The battery system 10 further includes a hydrogen-permeable membrane 60 that is in fluid communication with the cell interior 40. The hydrogen-permeable membrane 60 is configured to selectively allow any hydrogen (i.e., hydrogen gas) produced in the battery cell 20 to pass from the cell interior 40 through the hydrogen-permeable membrane 60 to outside of the battery cell 20 while substantially preventing other fluids from passing through the hydrogen-permeable membrane 60. Preventing other fluids from passing through the hydrogen permeable membrane 60 allows the battery cell 20 to operate properly. Examples of other fluids may include internal fluids (e.g., electrolyte compositions) and external fluids (e.g., water and other contaminates).

The hydrogen-permeable membrane 60 may have a hydrogen selectivity value (e.g., allowing hydrogen to pass through while substantially preventing fluids other than hydrogen from passing through the membrane 60) of at least 99.0%. For example, the hydrogen-permeable membrane 60 may have a hydrogen selectivity of at least 99.5% or at least 99.8% or at least 99.9%. As such, no more than 1% of fluids other than hydrogen pass through the membrane 60, such as no more than 0.5%, such as no more than 0.2%, for example, no more than 0.1%. Therefore, the hydrogen selectivity value is understood to indicate the amount of hydrogen passing through the hydrogen-permeable membrane 60 in relationship to other fluids. Hydrogen selectivity is defined as the amount of hydrogen that permeates or passes through a membrane per the amount of total fluids that permeates through the membrane.

The hydrogen-permeable membrane 60 may be selected or chosen from a polymeric, porous ceramic/carbon, a dense ceramic, a dense metal, or the like. The dense metal may include palladium. The hydrogen-permeable membrane 60 may be integrated into a portion of the cell enclosure 30 or may replace a portion of the cell enclosure 30.

The battery system 10 further includes a hydrogen sensor 70 in fluid communication with the hydrogen-permeable membrane 60 and is configured to detect a presence of hydrogen that has passed through the hydrogen-permeable membrane 60 and that is proximate the hydrogen sensor 70. The hydrogen sensor 70 is configured to detect the presence of hydrogen in an amount of from about 1 ppm to about 1000 ppm or greater. The hydrogen sensor 70 may contain a micro-fabricated point-contact hydrogen sensor for detecting hydrogen.

During adverse conditions (i.e., extreme heat) or operations (i.e., when the battery system 10 is storing or supplying electricity), the cell interior 40 may generate hydrogen within the cell interior 40. The hydrogen may advance through the cell interior 40 and pass through the hydrogen-permeable membrane 60 to the outside of the battery cell 20. Once outside of the battery cell 20, the hydrogen is detected by the hydrogen sensor 70.

In one example, the battery cell 20 may generate hydrogen because of an anomaly in the battery cell 20 from mechanical abuse, electrical abuse, or thermal abuse. Any of the abuses may result in a short circuit of the battery cell 20 and ultimately, lead to thermal runaway.

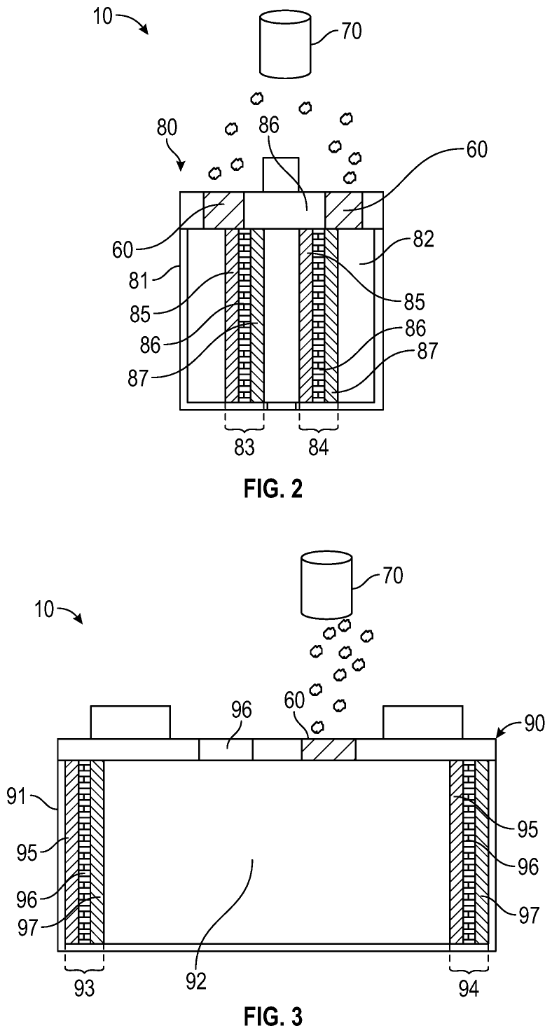

FIG. 2 illustrates a cross-sectional view of a battery system 10 including a battery cell 80. As illustrated and discussed below, in this example, the battery cell 80 may be configured as a cylindrical cell. The battery cell 80 includes a cell enclosure 81 that defines and is disposed about and encases a cell interior 82. In particular, for a cylindrical cell, the cell enclosure 81 may be formed, for example, from a nickel-plated steel material that is impermeable or acts as a barrier to fluids, e.g., liquids such as electrolyte compositions, and various gases, for example, hydrogen, oxygen, and the like. Non-limiting examples of cylindrical like materials for cell enclosures 81 for cylindrical cells includes nickel-plated steel, aluminum, or the like.

In an exemplary embodiment, at least one multi-layer stack 83 is disposed in the cell interior 82. The multi-layer stack includes a cathode 85, an anode 87, and a separator 86 disposed between the cathode 85 and the anode 87. It is to be understood that the battery cell 20 may include a single multi-layer stack, or more than two multi-layer stacks.

Each multi-layer stack 83 or 84 may include electrolytes (not shown) that facilitate the transport of ions, for example lithium ions, between the cathode 85 and anode 87. An electrolyte may be disposed between the anode 87 and the separator 86 and between the cathode 85 and the separator 86. Nonlimiting examples of electrolytes include liquid electrolytes (e.g., LiPF₆ LiBF₄, LiClO₄, or the like) and solid ceramic electrolytes (e.g., lithium metal oxides or the like).

As illustrated, in an exemplary embodiment, the hydrogen-permeable membrane 60 may be located or disposed where hydrogen gas may accumulate, for example, at the cell cover 86 of the battery cell 80 disposed. The hydrogen-permeable membrane 60 may be integrated into a portion of the cell cover 86 or may replace a portion of the cell cover 86. For example, the hydrogen-permeable membrane 60 may replace or integrate into a current interrupt device (CID) (not shown) and a pressure relief valve (PRV) device (not shown). Alternatively, the hydrogen-permeable membrane 60 may be integrated into a portion of the cell enclosure 81 or may replace a portion of the cell enclosure 81.

During operations, when the battery cell 80 is discharging or charging, the cell interior 82 may generate hydrogen within the cell interior 82. The hydrogen may advance through the cell interior 82 and pass through the hydrogen-permeable membrane 60 to the outside of the battery cell 80. Once outside of the battery cell 80, the hydrogen is detected by the hydrogen sensor 70.

FIG. 3 illustrates a cross-sectional view of a battery system 10 including a battery cell 90. As illustrated and discussed below, in this example, the battery cell 90 may be configured as a prismatic cell. The battery cell 90 includes a cell enclosure 91 that is disposed about and encases a cell interior 92. In particular, for a prismatic cell, the cell enclosure 91 may be formed, for example, from an aluminum material that is impermeable or acts as a barrier to fluids, e.g., liquids such as electrolyte compositions, and various gases, for example, hydrogen, oxygen, and the like. Non-limiting examples of cylindrical like materials for cell enclosures 91 for cylindrical cells includes aluminum, aluminum alloy, steel, plastic, or the like.

In an exemplary embodiment, at least one multi-layer stack 93 is disposed in the cell interior 92. The multi-layer stack includes a cathode 95, an anode 97, and a separator 96 disposed between the cathode 95 and the anode 97. It is to be understood that the battery cell 20 may include a single multi-layer stack, or more than two multi-layer stacks.

Each multi-layer stack 93 or 94 may include electrolytes (not shown) that facilitate the transport of ions, for example lithium ions, between the cathode 95 and anode 97. An electrolyte may be disposed between the anode 97 and the separator 96 and between the cathode 95 and the separator 96. Nonlimiting examples of electrolytes include liquid electrolytes (e.g., LiPF₆ LiBF₄, LiClO₄, or the like) and solid ceramic electrolytes (e.g., lithium metal oxides or the like).

As illustrated, in an exemplary embodiment, the hydrogen-permeable membrane 60 may be located or disposed where hydrogen gas may accumulate, for example, at the top of the battery cell 90 adjacent to a pressure-relief-burst membrane 96. The hydrogen-permeable membrane 60 may be integrated into a portion of the cell enclosure 91 or may replace a portion of the cell enclosure 91.

During adverse conditions (i.e., extreme heat) or operations (i.e., when the battery system 10 is storing or supplying electricity), the cell interior 92 may generate hydrogen within the cell interior 92. The hydrogen may advance through the cell interior 92 and pass through the hydrogen-permeable membrane 60 to the outside of the battery cell 90. Once outside of the battery cell 20, the hydrogen is detected by the hydrogen sensor 70.

Although a pouch cell (battery cell 20), a cylindrical cell (battery cell 80), and a prismatic cell (battery cell 90) are shown respectively in FIG. 1, FIG. 2, and FIG. 3, the battery system 10 may include other types of cells. The battery system 10 may include any electrochemical cell (or electrochemical device) that generates electrical energy from chemical reactions.

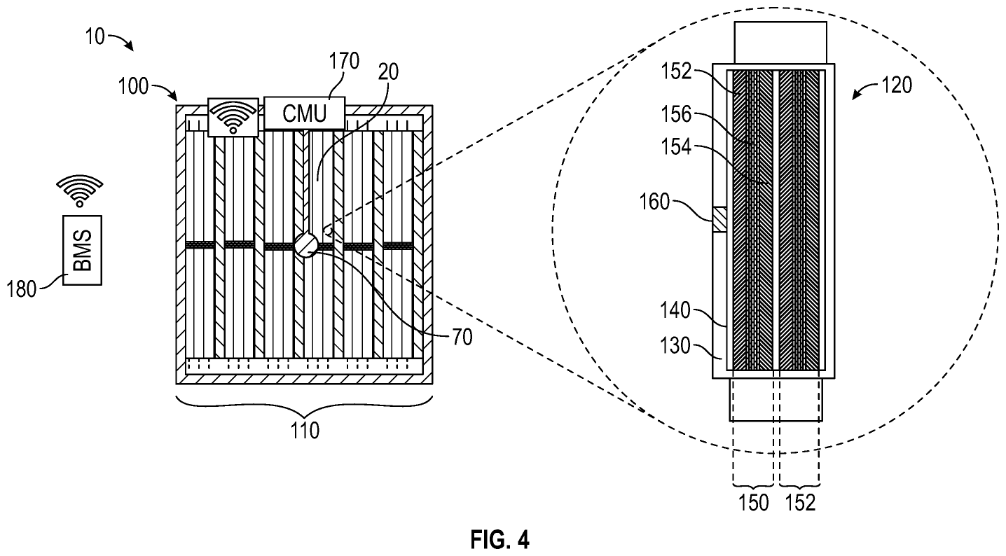

FIG. 4 is a schematic top view of a battery system 10 including a battery module 100, according to one or more embodiments of the disclosure. The battery module 100 includes a plurality of battery cells 110, which includes the battery cell 20 and a battery cell 120. Similar to the battery cell 20, the battery cell 120 includes a cell enclosure 130 that defines and is disposed about a cell interior 140 and at least one multi-layer stack 150 that is disposed in the cell interior 140. The multi-layer stack 150 includes a cathode 152, an anode 156 and a separator 154 disposed between the anode 156 and the cathode 152.

The battery system 10 further includes a hydrogen-permeable membrane 160 that is in fluid communication with the cell interior 140 and is configured to selectively allow any hydrogen produced in the battery cell 120 to pass from the cell interior 140 through the hydrogen-permeable membrane 160 to outside of the battery cell 120 while substantially preventing other fluids from passing through the hydrogen-permeable membrane 160.

The hydrogen sensor 70 is in fluid communication with the hydrogen-permeable membrane 160 and is configured to detect the presence of hydrogen that has passed through the hydrogen-permeable membrane 160 and is proximate the hydrogen sensor 70.

The battery system 10 further includes a cell management unit 170 that is in communication with the hydrogen sensor 70 and is operative to determine at least one of a concentration of hydrogen and a rate of change of a concentration of hydrogen with respect to time in response to the presence of hydrogen detected by the hydrogen sensor 70 and to compare at least one of the concentration and the rate of change to at least one of a corresponding predetermined threshold concentration value and a corresponding predetermined threshold rate of change value. The predetermined threshold concentration value may range from about 100 ppm to about 500 ppm or greater. The predetermined threshold rate of change value may range from about 20 ppm per minute to about 100 ppm per minute or greater.

The cell management unit 170 is operative to direct a control action in response to the concentration and/or the rate of change exceeding the corresponding predetermined threshold concentration value and/or a corresponding predetermined threshold rate of change value. The control action may include transmitting a warning notification to a receiving device, for example, a battery management system 180 as shown in FIG. 4. Examples of a receiving device may include a battery management system (BMS), a user computer and/or interface for a vehicle, an energy storage system, or any other systems that may receive electricity from the battery cell 120.

The cell management unit 170 may be a microcontroller-based, printed circuit board (PCB)-mounted sensor array. The cell management unit 170 may have a GPS transceiver and RF capabilities and may be packaged on or in a battery module 100.

During adverse conditions (i.e., extreme heat) or operations (i.e., when the battery system 10 is storing or supplying electricity), the battery cell 120 may generate hydrogen within the cell interior 130. The hydrogen may advance through the cell interior 130 and pass through the hydrogen-permeable membrane 160 to the outside of the battery cell 120. Once outside of the battery cell 120, the hydrogen is detected by the hydrogen sensor 70. Although the battery cell 120 is used as an illustrative example of hydrogen being released during adverse conditions or operations, any battery cell in the plurality of battery cells 110 may experience a release of hydrogen, which is detected by the hydrogen sensor 70.

The hydrogen sensor 70 communicates information (e.g., data regarding hydrogen) to the cell management unit 170. The cell management unit 170 determines the concentration of hydrogen and/or a rate of change of a concentration of hydrogen with respect to time in response to the presence of hydrogen detected by the hydrogen sensor 70. The cell management unit 170 compares the concentration and/or the rate of change to a predetermined threshold concentration value and/or a predetermined threshold rate of change value. If the threshold concentration and/or threshold rate of change value is satisfied, the cell management unit 170 performs one or more control actions, wherein the control action includes transmitting a warning notification to a receiving device, for example, the battery management system 180. The predetermined threshold concentration value may range from about 100 ppm to about 500 ppm or greater. The predetermined threshold rate of change value may range from about 20 ppm per minute to about 100 ppm per minute or greater.

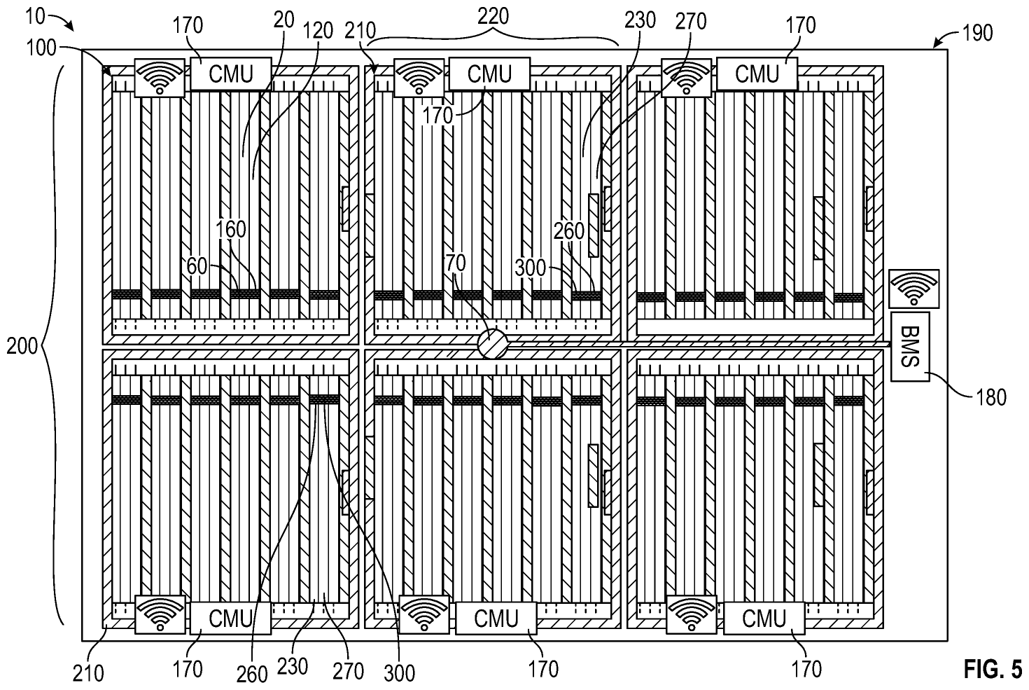

FIG. 5 is a schematic top view of a battery system 10 including a battery pack with one hydrogen sensor 70, according to one or more embodiments of the disclosure. The battery system 10 further includes a battery pack 190 including a plurality of battery modules 200. The plurality of battery modules 200 includes the battery module 100 and a battery module 210. The battery module 210 includes a plurality of battery cells 220, which includes a battery cell 230 and a battery cell 270.

Although the individual components of battery cell 230 are not shown in FIG. 5, like reference numerals in FIGS. 1-3 refer to like components of FIG. 5, the battery cell 230 includes a cell enclosure defining and disposed about a cell interior and at least one multi-layer stack that is disposed in the cell interior. The multi-layer stack of the battery cell 230 may include a cathode, an anode, and a separator disposed between the anode and the cathode. It is to be understood that the battery cell 230 may include one or more multi-layer stacks.

The battery system 10 further includes a hydrogen-permeable membrane 260 that is in fluid communication with the cell interior of the battery cell 230. The hydrogen-permeable membrane 260 is configured to selectively allow any hydrogen produced in the battery cell 230 to pass from the cell interior through the hydrogen-permeable membrane 260 to outside of the battery cell 230 while substantially preventing other fluids from passing through the hydrogen-permeable membrane 260.

Although the components of battery cell 270 are not shown in FIG. 5, the battery cell 270 includes a cell enclosure disposed about a cell interior and at least one multi-layer stack that is disposed in the cell interior. The multi-layer stack may include a cathode, an anode, a separator, and electrolytes disposed between the anode and the cathode. It is to be understood that the battery cell 270 may include one or more multi-layer stacks.

The battery system 10 further includes a hydrogen-permeable membrane 300 that is in fluid communication with the cell interior of the battery cell 270. The hydrogen-permeable membrane 300 is configured to selectively allow any hydrogen produced in the battery cell 270 to pass from the cell interior of the battery cell 270 through the hydrogen-permeable membrane 300 to outside of the battery cell 270 while substantially preventing other fluids from passing through the hydrogen-permeable membrane 300.

The hydrogen sensor 70 is in fluid communication with the hydrogen-permeable membrane 160, the hydrogen-permeable membrane 260, and the hydrogen-permeable membrane 300. The hydrogen sensor 70 is configured to detect the presence of hydrogen that has passed through the hydrogen-permeable membrane 160, the hydrogen-permeable membrane 260, and/or the hydrogen-permeable membrane 300 and that is proximate to the hydrogen sensor 70.

The hydrogen sensor 70 is also in fluid communication with the hydrogen-permeable membranes of each plurality of battery cells within the plurality of battery modules of the battery pack 190. The hydrogen sensor 70 is configured to detect the presence of hydrogen that has passed through the hydrogen-permeable membranes of each of the plurality of battery cells and that is proximate to the hydrogen sensor 70.

The battery system 10 further includes a battery management system 180 in communication with the hydrogen sensor 70 and is operative to determine a concentration of hydrogen and/or a rate of change of a concentration of hydrogen with respect to time in response to the presence of hydrogen detected by the hydrogen sensor 70 and to compare the concentration and/or the rate of change to a corresponding predetermined threshold concentration value and/or a corresponding predetermined threshold rate of change value. The predetermined threshold concentration value may range from about 100 ppm to about 500 ppm or greater. The predetermined threshold rate of change value may range from about 20 ppm per minute to about 100 ppm per minute or greater.

The battery management system 180 is operative to direct a control action in response to the concentration and/or the rate of change exceeding the corresponding predetermined threshold concentration value and/or a corresponding predetermined threshold rate of change value, wherein the control action includes transmitting a warning notification to a receiving device. Examples of a receiving device may include user computer and/or interface for a vehicle, energy storage system, and any other systems that receive electricity from a battery cell.

The battery management system 180 is configured to control functions of the battery system 10 including, but not limited to, controlling switching of individual battery modules or battery cells of the battery system 10, monitoring operating parameters, diagnosing faults, etc. The battery management system 180 may be further configured to communicate with the plurality of battery modules 200.

The battery management system 180 includes a processor (e.g., a central processing unit, microprocessor, application-specific integrated circuit, etc. and sufficient amounts and types of memory, including tangible, non-transitory memory such as read only memory, optical, magnetic, flash memory, and the like. The battery management system 180 also includes application-sufficient amounts of random-access memory, electrically-erasable programmable read only memory, and the like, as well as a high-speed clock, analog-to-digital and digital-to-analog circuitry, and input/output circuitry and devices, as well as appropriate signal conditioning and buffer circuitry.

During adverse conditions (i.e., extreme heat) or operations (i.e., when the battery system 10 is storing or supplying electricity), the battery cell 20 in the plurality of battery modules 200 of the battery pack 190 may generate hydrogen within the cell interior 40 of the battery cell 20. The hydrogen may advance through the cell interior 40 and pass through the hydrogen-permeable membrane 60 to the outside of the battery cell 20. Once outside of the battery cell 20, the hydrogen is detected by the hydrogen sensor 70. Battery cell 20 is used for illustrative purposes, but one or more battery cells may generate hydrogen.

The hydrogen sensor 70 communicates information (e.g., data regarding hydrogen) to the battery management system 180. The battery management system 180 determines the concentration of hydrogen and/or a rate of change of a concentration of hydrogen with respect to time in response to the presence of hydrogen detected by the hydrogen sensor 70. The battery management system 180 compares the concentration and/or the rate of change to a predetermined threshold concentration value and/or a predetermined threshold rate of change value. The predetermined threshold concentration value may range from about 100 ppm to about 500 ppm or greater. The predetermined threshold rate of change value may range from about 20 ppm per minute to about 100 ppm per minute or greater.

If the threshold concentration and/or threshold rate of change value is satisfied, the battery management system 180 performs one or more control actions, wherein the control action includes transmitting a warning notification to a receiving device. Examples of a receiving device may include a user computer and/or interface for a vehicle, energy storage system, and any other systems that receive electricity from the battery cell.

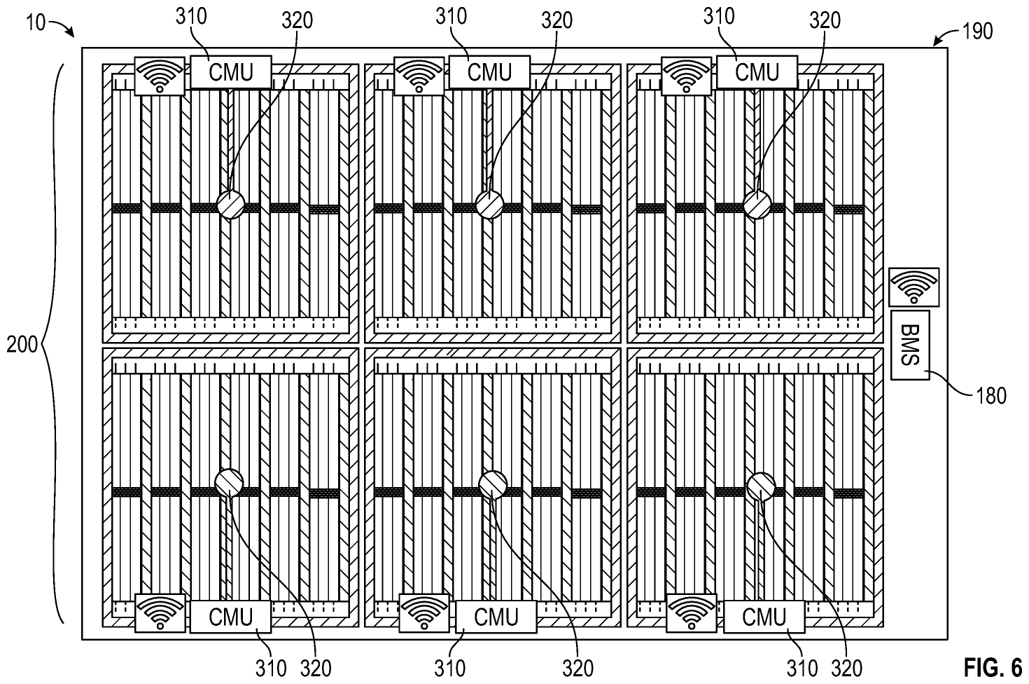

FIG. 6 is a schematic top view of a battery system 10 including a battery pack 190 with multiple hydrogen sensors 320, according to one or more embodiments of the disclosure. The battery system 10 includes a battery pack 190 including a battery management system 180 and a plurality of battery modules 200. Each battery module 200 includes a hydrogen sensor 320 and a plurality of battery cells. Each battery cell includes a cell enclosure disposed about a cell interior and at least one multi-layer stack that is disposed in the cell interior. The one multi-layer stack includes a cathode, an anode, and a separator disposed between the anode and the cathode. It is to be understood that each battery cell 20 may include one or more multi-layer stacks.

The battery system 10 further includes a corresponding hydrogen-permeable membrane in fluid communication with the cell interior and configured to selectively allow any hydrogen produced in the corresponding battery cell to pass from the cell interior through the corresponding hydrogen-permeable membrane to the outside of the corresponding battery cell while substantially preventing other fluids from passing through the corresponding hydrogen-permeable membrane.

The corresponding hydrogen sensor is in fluid communication with the hydrogen-permeable membrane of each battery cell of the corresponding battery module and is configured to detect a presence of hydrogen that has passed through the hydrogen-permeable membrane of each battery cell and that is proximate the hydrogen sensor.

The corresponding hydrogen sensors 320 are in communication with corresponding cell management unit 310. The corresponding cell management units 310 are in communication with the battery management system 180. The battery management system 180 is operative to determine for each module a concentration of hydrogen and/or a rate of change of a concentration of hydrogen with respect to time in response to the presence of hydrogen detected by the corresponding hydrogen sensor and to compare the concentration and/or the rate of change to a corresponding predetermined threshold concentration value and/or a corresponding predetermined threshold rate of change value. The predetermined threshold concentration value may range from about 100 ppm to about 500 ppm or greater. The predetermined threshold rate of change value may range from about 20 ppm per minute to about 100 ppm per minute or greater.

During adverse conditions (i.e., extreme heat) or operations (i.e., when the battery system 10 is storing or supplying electricity), the battery cell 20 in the plurality of battery modules 200 of the battery pack 190 may generate hydrogen within the cell interior 40 of the battery cell 20. The hydrogen may advance through the cell interior 40 and pass through the hydrogen-permeable membrane 60 to the outside of the battery cell 20. Once outside of the battery cell 20, the hydrogen is detected by the hydrogen sensor 320. Battery cell 20 is used for illustrative purposes, but one or more battery cells may generate hydrogen.

The hydrogen sensor 320 communicates information (e.g., data regarding hydrogen) to the corresponding cell management units 310, which communicates to battery management system 180. The battery management system 180 determines the concentration of hydrogen and/or a rate of change of a concentration of hydrogen with respect to time in response to the presence of hydrogen detected by the hydrogen sensor 320. The battery management system 180 compares the concentration and/or the rate of change to a predetermined threshold concentration value and/or a predetermined threshold rate of change value. The predetermined threshold concentration value may range from about 100 ppm to about 500 ppm or greater. The predetermined threshold rate of change value may range from about 20 ppm per minute to about 100 ppm per minute or greater.

If the threshold concentration and/or threshold rate of change value is satisfied, the battery management system 180 performs one or more control actions, wherein the control action includes transmitting a warning notification to a receiving device. Examples of a receiving device may include a user computer and/or interface for a vehicle, energy storage system, and any other systems that receive electricity from the battery cell. Another control action may include supplying cooling resources to the battery cell when the battery cell is overheated.

In an exemplary embodiment, the battery system 10 is operably disposed, incorporated, or otherwise used in a vehicle, for example, a motor vehicle. As used herein a “vehicle” is understood to mean a device configured for transporting people, things, objects, or the like. Non-limiting examples of motor vehicles (e.g., internal combustion engine (ICE) vehicles, electric motor vehicles including electric battery and fuel cell vehicle or the like) include land vehicles (e.g., cars, trucks, motorcycles, electric bike, buses, trains or the like), aerial vehicles (e.g., airplanes, helicopters, unmanned aerial vehicles or the like), water vehicles (e.g., boats, watercrafts, or the like) and amphibious vehicles (e.g., hovercrafts or the like).

While the best modes for carrying out the disclosure have been described in detail, those familiar with the art to which this disclosure relates will recognize various alternative designs and embodiments for practicing the disclosure within the scope of the appended claims.

Any of the dimensions, configurations, etc. discussed herein may be varied as needed or desired to be different than any value or characteristic specifically mentioned herein or shown in the drawings for any of the embodiments.

It will be apparent to those skilled in the art that various modifications and variations can be made to the embodiments of the apparatus and methods of assembly as discussed herein without departing from the scope or spirit of the disclosure(s). Other embodiments of this disclosure will be apparent to those skilled in the art from consideration of the specification and practice of the various embodiments disclosed herein. For example, some of the equipment may be constructed and function differently than what has been described herein and certain steps of any method may be omitted, performed in an order that is different than what has been specifically mentioned or in some cases performed simultaneously or in sub-steps. Furthermore, variations or modifications to certain aspects or features of various embodiments may be made to create further embodiments and features and aspects of various embodiments may be added to or substituted for other features or aspects of other embodiments to provide still further embodiments.

What is claimed is:

1. A battery system comprising:
a first battery cell comprising:
a first cell enclosure disposed about a first cell interior; and
at least one first multi-layer stack that is disposed in the first cell interior and that comprises a first cathode, a first anode and a first separator disposed between the first anode and the first cathode; and
a first hydrogen-permeable membrane in fluid communication with the first cell interior and configured to selectively allow any hydrogen produced in the first battery cell to pass from the first cell interior through the first hydrogen-permeable membrane to outside of the first battery cell while substantially preventing other fluids from passing through the first hydrogen-permeable membrane.

2. The battery system of claim 1, further comprising a first hydrogen sensor in fluid communication with the first hydrogen-permeable membrane and configured to detect a presence of hydrogen that has passed through the first hydrogen-permeable membrane and that is proximate the first hydrogen sensor.

3. The battery system of claim 2, wherein the first hydrogen sensor is configured to detect the presence of hydrogen in an amount of from about 1 ppm to about 1000 ppm or greater.

4. The battery system of claim 2, further comprising a first battery module comprising a first plurality of battery cells including the first battery cell and a second battery cell, wherein the second battery cell comprises:
a second cell enclosure defining and disposed about a second cell interior; and
at least one second multi-layer stack that is disposed in the second cell interior and that comprises a second cathode, a second anode and a second separator disposed between the second anode and the second cathode; and
a second hydrogen-permeable membrane in fluid communication with the second cell interior and configured to selectively allow any hydrogen produced in the second battery cell to pass from the second cell interior through the second hydrogen-permeable membrane to outside of the second battery cell while substantially preventing other fluids from passing through the second hydrogen-permeable membrane.

5. The battery system of claim 4, wherein the first hydrogen sensor is in fluid communication with the second hydrogen-permeable membrane, is configured to detect the presence of hydrogen that has passed through the second hydrogen-permeable membrane, and is proximate the first hydrogen sensor.

6. The battery system of claim 5, further comprising a cell management unit in communication with the first hydrogen sensor and operative to determine a concentration of hydrogen and/or a rate of change of the concentration of hydrogen with respect to time in response to the presence of hydrogen detected by the first hydrogen sensor and to compare the concentration and/or the rate of change to a corresponding predetermined threshold concentration value and/or a corresponding predetermined threshold rate of change value.

7. The battery system of claim 6, wherein the cell management unit is operative to direct a control action in response to the concentration and/or the rate of change exceeding the corresponding predetermined threshold concentration value and/or the corresponding predetermined threshold rate of change value, wherein the control action includes transmitting a warning notification to a receiving device.

8. The battery system of claim 7, wherein the receiving device includes a battery management system.

9. The battery system of claim 4, further comprising a battery pack comprising a plurality of battery modules including the first battery module and a second battery module, wherein the second battery module comprises a second plurality of battery cells including a third battery cell and a fourth battery cell, wherein the third battery cell comprises:
a third cell enclosure defining and disposed about a third cell interior; and
at least one third multi-layer stack that is disposed in the third cell interior and that comprises a third cathode, a third anode and a third separator disposed between the third anode and the third cathode; and
a third hydrogen-permeable membrane in fluid communication with the third cell interior and configured to selectively allow any hydrogen produced in the third battery cell to pass from the third cell interior through the third hydrogen-permeable membrane to outside of the third battery cell while substantially preventing other fluids from passing through the third hydrogen-permeable membrane, and wherein the fourth battery cell comprises:
a fourth cell enclosure defining and disposed about a fourth cell interior; and
at least one fourth multi-layer stack that is disposed in the fourth cell interior and that comprises a fourth cathode, a fourth anode and a fourth separator disposed between the fourth anode and the fourth cathode; and
a fourth hydrogen-permeable membrane in fluid communication with the fourth cell interior and configured to selectively allow any hydrogen produced in the fourth battery cell to pass from the fourth cell interior through the fourth hydrogen-permeable membrane to outside of the fourth battery cell while substantially preventing other fluids from passing through the fourth hydrogen-permeable membrane.

10. The battery system of claim 9, wherein the first hydrogen sensor is in fluid communication with the second hydrogen-permeable membrane, the third hydrogen-permeable membrane, and the fourth hydrogen-permeable membrane and is configured to detect the presence of hydrogen that has passed through the second hydrogen-permeable membrane, the third hydrogen-permeable membrane, the fourth hydrogen-permeable membrane, or a combination thereof and that is proximate the first hydrogen sensor.

11. The battery system of claim 10, further comprising a battery management system in communication with the first hydrogen sensor and operative to determine a concentration of hydrogen and/or a rate of change of the concentration of hydrogen with respect to time in response to the presence of hydrogen detected by the first hydrogen sensor and to compare the concentration and/or the rate of change to a corresponding predetermined threshold concentration value and/or a corresponding predetermined threshold rate of change value.

12. The battery system of claim 11, wherein the battery management system is operative to direct a control action in response to the concentration and/or the rate of change exceeding the corresponding predetermined threshold concentration value and/or a corresponding predetermined threshold rate of change value, wherein the control action includes transmitting a warning notification to a receiving device.

13. The battery system of claim 1, wherein the battery system is operably disposed in a vehicle.

14. The battery system of claim 1, wherein the hydrogen-permeable membrane has a hydrogen selectivity value of at least 99.0%.

15. The battery system of claim 1, wherein the hydrogen-permeable membrane is chosen from a polymeric, a porous ceramic/carbon, a dense ceramic, a dense metal, and combinations thereof.

16. The battery system of claim 15, wherein the dense metal comprises palladium.

17. The battery system of claim 1, wherein the first battery cell is chosen from a pouch cell, a prismatic cell, or a cylindrical cell.

18. A battery system comprising:
a battery module comprising a cell management unit, a hydrogen sensor in communication with the cell management unit, and a plurality of battery cells, each of the battery cells comprising:
a cell enclosure disposed about a cell interior; and
at least one multi-layer stack that is disposed in the cell interior and that comprises a cathode, an anode and a separator disposed between the anode and the cathode; and
a corresponding hydrogen-permeable membrane in fluid communication with the cell interior and configured to selectively allow any hydrogen produced in the corresponding battery cell to pass from the cell interior through the corresponding hydrogen-permeable membrane to outside of the corresponding battery cell while substantially preventing other fluids from passing through the corresponding hydrogen-permeable membrane; and
wherein the hydrogen sensor is in fluid communication with the hydrogen-permeable membrane of each of the battery cells and is configured to detect a presence of hydrogen that has passed through the hydrogen-permeable membrane and that is proximate the hydrogen sensor,
wherein the cell management unit is operative to determine a concentration of hydrogen and/or a rate of change of the concentration of hydrogen with respect to time in response to the presence of hydrogen detected by the hydrogen sensor and to compare the concentration and/or the rate of change to a corresponding predetermined threshold concentration value and/or a corresponding predetermined threshold rate of change value.

19. A battery system comprising:
a battery pack comprising a battery management system and a plurality of battery modules, each battery module comprising a hydrogen sensor and a plurality of battery cells, each of the battery cells comprising:
a cell enclosure defining and disposed about a cell interior; and
at least one multi-layer stack that is disposed in the cell interior and that comprises a cathode, an anode and a separator disposed between the anode and the cathode; and
a corresponding hydrogen-permeable membrane in fluid communication with the cell interior and configured to selectively allow any hydrogen produced in the corresponding battery cell to pass from the cell interior through the corresponding hydrogen-permeable membrane to outside of the corresponding battery cell while substantially preventing other fluids from passing through the corresponding hydrogen-permeable membrane; and
wherein the hydrogen sensor is in fluid communication with the hydrogen-permeable membrane of each of the battery cells and is configured to detect a presence of hydrogen that has passed through the hydrogen-permeable membrane of each battery cell and that is proximate the hydrogen sensor,
wherein the hydrogen sensor is in communication with the battery management system; and
wherein the battery management system is operative to determine for each module a concentration of hydrogen and/or a rate of change of the concentration of hydrogen with respect to time in response to the presence of hydrogen detected by the corresponding hydrogen sensor and to compare the concentration and/or the rate of change to a corresponding predetermined threshold concentration value and/or a corresponding predetermined threshold rate of change value.

20. The battery system of claim 19, wherein the battery system is operably disposed in a vehicle.
